(19) United States
(12) Patent Application Publication
(10) Pub. No.: US 2008/0065529 A1
(43) Pub. Date: Mar. 13, 2008

(54) Method and system for securitizing contracts valued on an index

(75) Inventors: Christopher K. Bowen, Bronxville, NY (US); Donald Carden, Pelham, NY (US); Zoltan L. Guttman, New York, NY (US); Richard Horowitz, Larchmont, NY (US); David Salomon, Beverly Hills, CA (US); Lanny A. Schwartz, Philadelphia, PA (US); David Yeres, Chappaqua, NY (US)

Correspondence Address: Mitchell S. Feller, Esq., Clifford Chance US LLP, 200 Park Avenue, New York, NY, 10016, US

(73) Assignees: New York Mercantile Exchange, Inc.; Philadelphia Stock Exchange, Inc.

(21) Appl. No.: 11/982,649

(22) Filed: Nov. 5, 2007

Related U.S. Application Data
(62) Division of application No. 10/307,661, filed on Dec. 2, 2002.
(60) Provisional application No. 60/393,487, filed on Jul. 3, 2002.

(51) Int. Cl. G06Q 40/00

(52) U.S. Cl. 705/37; 705/36 R

(57) ABSTRACT

In a method and system for securitizing contracts valued on an index, a special purpose entity (SPE) is provided and holds as substantially all of its assets a derivative contract with a contract dealer. The contract has an initial notional value and is tied to an index related to items traded by a multilateral transactional execution facility, such as futures contracts traded on an exchange. The held contract is also scalable so that the notional value can be increased on demand in exchange for a corresponding payment to the contract dealer and decreased on demand in exchange for a corresponding payment from the contract dealer. The SPE issues exchange tradable securities that derive value based on the value of the contract held by the SPE. To issue additional shares, assets are contributed to the contract dealer who increases the notional value of the contract held by the SPE. The increase in value of the contract supports the issuance of additional shares. Shares are redeemed by terminating some or all of the contract whereby the contract dealer reduces the notional value and provides a termination payment based on the amount of the termination and the value of the index. In one embodiment, investors purchase shares by providing to the contract dealer both a cash payment and a futures contract, the combination having a value corresponding to the value of the shares to be issued, and where the futures contract can then be used by the contract dealer to hedge the. forward contract between the contract dealer and the SPE.

### CROSS REFERENCE TO RELATED APPLICATIONS

This application is a divisional application of U.S. patent application Ser. No. 10/307,661, filed Dec. 2, 2002, which claims priority under 35 U.S.C. § 119 to U.S. Provisional Application Ser. No. 60/393,487 filed on Jul. 3, 2002 and entitled “A Method And System For Securitizing Contracts Valued On An Index,” the entire contents of which is hereby expressly incorporated by reference.

### FIELD OF THE INVENTION

This invention is related to a financial process which permits the user to create a security of a special purpose entity having among its assets contracts or swaps based on a measure of value.

### BACKGROUND

Trading of fund units on a securities exchange is well established. Closed end funds have traded for some time. Exchange traded funds (“ETFs”), a cross between a closed end fund and an open end fund are securities based on a fund that can be traded in a manner similar to conventional securities shares. ETFs have successfully traded since the early 1990's. Known traded fund units and ETFs are generally securitized forms of other securities, such as stocks, or securities-based instruments. For example, a product called the SPDR®, which is short for Standard and Poors Depository Receipt, is traded on the American Stock Exchange and the traded shares represent a fractional share of a particular basket of stocks, such as stocks in the Standard and Poors 500 index (S&P500). ETFs and related derivative instruments may also be derived from mutual funds. A particular method for securitizing mutual funds is disclosed in U.S. Pat. No. 6,088,685 to Kiron et al., entitled “Open End Mutual Fund Securitization Process.”

A variety of other techniques are known in which a trust is funded with various types of financial instruments and then issues securities based on the value of the held assets. However, current techniques do not provide a flexible mechanism by which an investor can participate in the price changes in a derivatives market, such as a market of futures contracts based on an index published by the New York Mercantile Exchange, without having to actually participate in the derivatives market itself and expose themselves to liability that may exceed their initial investment. Moreover, such known techniques do not provide a flexible mechanism to permit the trust to issue and redeem shares on demand, without requiring the trust to purchase or sell discrete assets.

### SUMMARY OF THE INVENTION

Accordingly, it is an object of the present invention to provide a method of securitizing contracts having a value tied to a derivatives market.

It is a further object of the present invention to provide a mechanism whereby a party to a securitized contract can hedge the risk associated with the contract.

More particularly, the present invention provides for a class of tradable securities that are issued from a trust or other special purpose entity (“SPE”) and are linked in value to an index, such as an index derived from the trading of futures contracts (or via other means) or another measure of value, and where the securities can be listed for trading on a securities exchange or similar market.

An index is published by a multilateral transactional execution facility (“MTEF”) or a third party based upon items traded by the MTEF. In one embodiment, the MTEF is a futures exchange and the index is based upon the settlement values of contracts traded on the MTEF, such as futures contracts listed on the New York Mercantile Exchange (“NYMEX”). In return for cash and/or other acceptable assets, a contract dealer enters into a derivative contract, such as a forward contract or swap, with the SPE. The derivative contract has a value that is linked to the index and is based on the value of the initial contribution at the time of the contribution. The derivative contracts can be scalable so that the value of the contract can be increased by making additional contributions. Alternatively, additional contracts can be purchased instead of scaling existing contracts. A contract can be redeemed in whole or part and, upon redemption, the contract dealer is obligated to make a termination payment to the SPE based upon the current index value and the amount of the contract being redeemed. The contract dealer may also be required to make periodic payments to the SPE.

The derivative contracts are held by the SPE as one of its primary assets. The SPE issues tradable securities which can then be freely traded on a securities market, such as the Philadelphia Stock Exchange (“PHLX”). The tradable securities can be structured so that they are not subject to recharacterization as futures or related options which are restricted by the Commodity Exchange Act by ensuring that the securities fall within the safe harbor provision provided by that Act for hybrid securities.

Newly issued shares may be purchased from the SPE by certain authorized persons (each a “securities dealer”) for themselves or on behalf of others. When a securities dealer purchases such newly issued shares, e.g., in creation unit sized blocks, the value of the shares is determined based upon the index at the close of trading. The securities dealer first provides cash and/or other acceptable assets to the contract dealer, either directly or through the SPE. The contract dealer increases the value of its contract with the SPE by a corresponding amount or enters into a new contract with the SPE, as appropriate. The SPE then can, based on the value of the held contract, issue the tradable securities to the securities dealer. When the securities dealer wants to redeem securities for itself or on behalf of others, it tenders the securities in creation unit sized blocks (or as otherwise appropriate) to the SPE. The SPE or its agent instructs the contract dealer to reduce the notional amount of the contract by an amount related to the designated number of units or to terminate one or more particular contracts in an amount corresponding to the share value at the current index price and the number of securities being redeemed. The contract dealer then makes a payment to the SPE which is equivalent to the reduction in value of the contract and this payment is passed to the securities dealer.

Advantageously, this methodology allows exchange tradable securities to be provided based upon futures indices, such as indices for energy and metals. The securities can be issued and redeemed daily at the end of each trading day and can be traded on suitable securities exchanges. Options, futures, and other derivative instruments based upon these tradable securities can also be created. The trading price for the issued security is set by market forces, e.g., with reference to the bids and offers for the security as well as to real time future contract prices or the index published by the MTEF. Although the “economic experience” of holding these tradable shares will differ from the experience of holding futures contracts, the tradable shares allow investors to participate in the price changes on which the futures contracts are based without having to actually participate in the futures market itself. In addition, unlike direct investors in a futures market, the liability for an investor in the tradable shares is capped at their initial investment.

More generally, the present invention allows trading in a class of instruments to be moved from one market type with an associated regulatory regime, such as that for futures contracts, to another market with a different regulatory regime, such as that for tradable securities.

In various futures markets, as held futures contracts expire, holders of these futures typically “roll” the futures and obtain new contracts in their place. In one embodiment, the index is structured to reflect the characteristic roll of futures in the relevant market. Advantageously, by building in the roll of the futures into the index, investors in the tradable securities can hold a securitized position in the futures contracts without having to roll. This is particularly advantageous for investor groups that may not be authorized to trade futures or may find it cumbersome to do so, but want to invest, in some manner, in the value of futures. Moreover, aggregating the roll across all investors can also provide various efficiencies.

The SPE can be configured so that there is a minimized fund level taxation and so that investors or other holders are not subject to taxation on any phantom income. (Some fund level tax may exist due to profit and loss on rebalancing by the SPE.) Advantageously, the up-front payment to the contract dealer from the securities dealer can be structured to substantially minimize the risk with regard to changes in the index value to which that dealer is exposed.

Contract dealers can hedge the contracts with futures that are traded on the MTEF, thus increasing trading volume on the MTEF by the contract provider as well as by specialists or market makers on the relevant securities exchange. In a particular embodiment, a securities dealer purchasing shares from the SPE provides to the contracting agent (either directly or through the SPE) a cash payment along with a “payment in kind” equal to the value of the shares to be issued. The payment in kind is preferably in the form of a derivative contract that has a notional amount similar to the price of shares to be issued and a value that is closely correlated with the index on which the contracts with the SPE are based. A particular derivative contract well suited for this purpose is a futures contract relating to the relevant index. The futures contract will have a net value at its initiation equal to the margin deposit required to acquire the futures contract (perhaps with additional overhead) and this margin deposit can be paid by the securities dealer and the cash component of the contribution adjusted accordingly. The futures contract can then be used by the contract dealer to hedge the derivative contract between the contract dealer and the SPE and as a source of collateral to assure the SPE that the contract dealer can meet its payment obligations to the SPE.

### BRIEF DESCRIPTION OF THE FIGURES

The foregoing and other features of the present invention will be more readily apparent from the following detailed description and drawings of illustrative embodiments of the invention in which:

FIGS. 1a and 1b are diagrams showing the general flow of the issuance of tradable securities according to aspects of the invention;

FIGS. 2a and 2b are diagrams showing the general flow of the redemption of tradable securities according to aspects of the invention; and

FIGS. 3a and 3b are diagrams showing the general flow of the issuance of tradable securities in a preferred environment of this aspect of the invention.

### DETAILED DESCRIPTION OF THE PREFERRED EMBODIMENTS

The present invention provides new methods and systems for providing exchange traded funds (“ETFs”) whose securities can be traded on various national securities exchanges. According to one aspect of the invention, a special purpose entity (“SPE”), such as a trust, is established which will hold as its primary asset one or more index-linked derivative contracts, such as swap contracts, with one or more contract dealers. The derivative contracts have a value which is tied to a specific published index (e.g., the contact value can be determined with reference to an index value) and contracts are issued based on an initial contribution of assets. The contracts can be scalable so that they can be increased in size by making additional contributions to the contract dealer or diminished in size in exchange for a termination payment by the contract dealer of a corresponding amount. This avoids the need to issue new contracts on a frequent basis to accommodate additional investments or terminations. The contracts can also be terminated on a daily basis, in whole or part, and, upon such a redemption, the contract dealer makes a payment based upon the current value of the index and the size of the termination.

The index upon which the contracts are based can be any suitable value. Preferably, the index is derived from the traded, deemed, or settled prices or values of instruments as provided by a multilateral transactional execution facility (“MTEF”), such as an existing exchange and, most preferably, from the settlement values of futures contracts, such as energy or metals futures as traded on the NYMEX. However, the index can also be derived from other factors which need not be financial in nature, such as weather or insurance risk related factors.

In a preferred embodiment, the SPE pays the full price of a derivative contract at its inception. Preferably, the SPE does not invest in any other securities or similar interests so that the “assets” of the SPE are substantially comprised of one or more index-linked derivative contracts. The SPE then issues exchange tradable securities, e.g., to suitable securities dealers. The issued securities derive value from the underlying value of the contract(s) held by the SPE. These securities can be freely traded in a securities market at a price which is independently determined by market forces. The price of the securities is expected to generally track the value of the underlying assets held by the SPE, e.g., the value of the contracts divided by the number of outstanding shares. Typically, the net asset value (“NAV”) of the assets held by the SPE can be calculated at the close of a trading day and estimated during trading based on, e.g., a current value of the index on which the held contract is based. Other factors, such as SPE costs and any periodic interest rate related payments to the SPE on the contracts can also be considered as appropriate.

As will be appreciated, for the SPE to issue additional shares without diluting the value of existing shares, the value of the SPE must be increased by a proportional amount. This can be accomplished, according to an aspect of the invention, by increasing the value of the forward contract(s) held by the SPE by a related amount. To accomplish this, asset contributions are transferred to one or more contract dealers who, in response, increase the notional amount of the respective contract(s). The size of the transfer is dependent upon the needed increase in the notional amounts of the contracts and the value of the index at the time the increase is needed. A specific composition of the transfer which minimizes the risk exposure of the contract dealer is discussed below. Analogously, when shares are redeemed, the contract dealer reduces the size of the contract (by partial or total termination as the case may be) based on the size of the redemption and makes a transfer to the SPE which depends on the size of the reduction and the value of the index. The notional amount of a contract can be changed at any specified time. Preferably, the contracts are scaled as appropriate on a daily basis following the end of trading and can be based on any increase or decrease in the number of outstanding securities of the SPE.

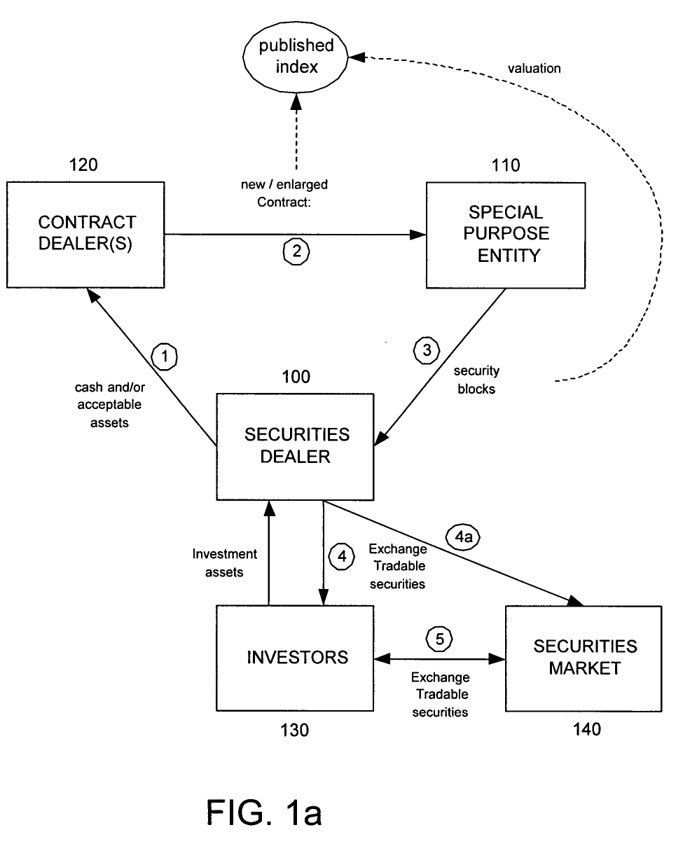

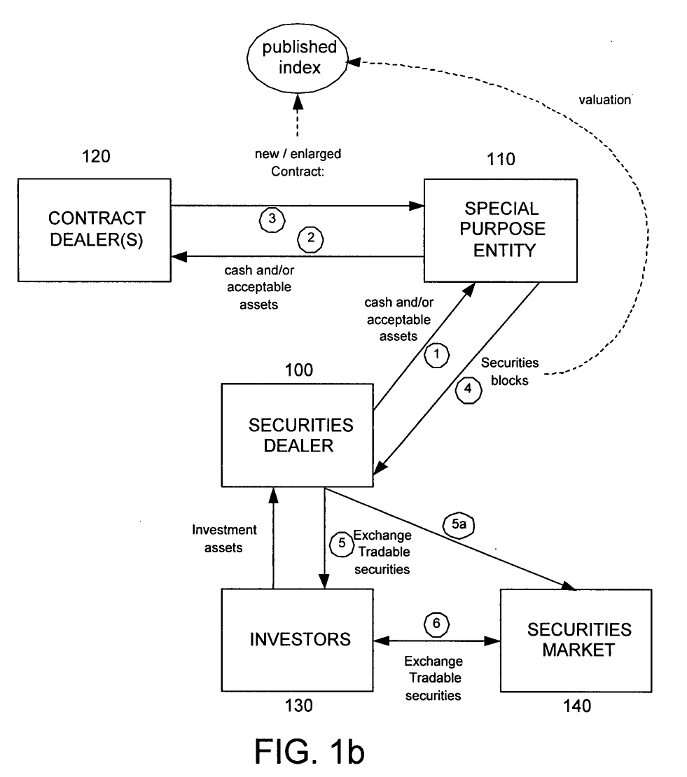

FIG. 1a is a representative diagram of various entities associated with aspects of the present invention that further shows a high-level overview of a process flow for the purchase of securities from the SPE according to a first embodiment of the invention. A securities dealer 100 wanting to purchase securities from the SPE 110 transfers assets to the contract dealer 120 equal to the cost of increasing the size of the contract by the desired number of shares. (Step 1) The incremental increase in value required to cover the additional shares to be issued by the SPE 110 to the contract dealer 120 can be determined based upon the terms of the contract and the linked index value. For a typical contract, this amount will be determined based upon (a) the number of units to be purchased times (b) the notional value (price) of each unit times (c) the determined index value, e.g., for the trading session concluding immediately after the order is placed. Of course, other valuation formulations could be used as appropriate.

The value transferred to the contract dealer 120 can be cash and/or other acceptable assets, such as futures contracts or other assets the contract dealer can use to hedge the contract with the SPE. As discussed more fully below, in the preferred implementation, the value transferred comprises cash along with a futures contract having a value reflected in the index on which the contract between the contract dealer 120 and the SPE 110 is based, and where the combined value of the contribution is equal to the value of the securities to be issued to the security dealer 100. In a particular embodiment, the derivative contract is structured so that only a single initial payment to the contract dealer 120 is required.

The index value will typically not be known at the time the purchase order is issued by the securities dealer and, thus, there will be some uncertainty as to the actual cost of the units to be issued until the index value is set, such as at the end of a trading day. This uncertainty arises in other contexts and appropriate mechanisms for arranging for appropriate transfer by the securities dealer 100 will be known to those of skill in the art. As will be recognized, if redemption and creation are permitted after the close of trading, the value may be known by the securities dealer 100 at the time the order is placed.

After receiving the transfer, the contract dealer 120 increases the size of the derivative contract to reflect the amount of the contribution that was made, e.g., by increasing the notional amount of the appropriate contract(s). (Step 2) Because the amount of the contribution is determined by the number of securities to be issued by the SPE 110, the value of contract, and thus the value of assets held by the SPE 110, is also increased by an amount sufficient to allow the SPE 110 to issue the specified number of securities to the securities dealer 100. (Step 3)

Typically, the securities dealer 100 will purchase securities on behalf of, or for resale to, other investors 130. This purchase can be funded either by payments received from the investors 130 or can be funded by the securities dealer. After receiving the issued securities from the SPE 110, the security dealer 100 can then distribute them to the various investors 130 as appropriate who can hold or trade them on a suitable securities market 140 as desired. (Steps 4, 5) Alternatively, the securities dealer can directly offer the securities for sale on the securities market 140 where they can then be purchased by other investors. (Steps 4a, 5)

FIG. 1b shows a second embodiment of the invention as it pertains to the purchase of securities. The flow of FIG. 1b is generally similar to that shown in FIG. 1a except that the securities dealer 100 makes a transfer to the SPE 110 for the purchase of the securities rather than providing value directly to the contract dealer 120. The SPE 110 is responsible for forwarding the received funds or cash and acceptable assets of equivalent value and of a suitable composition to the contract dealer 120. The method then progresses as discussed above with respect to FIG. 1a.

In some embodiments, the SPE 110 may have multiple contracts with one or more contract dealers 120 (not shown). In such an embodiment, the SPE 110 can apply the contribution to a single contract or distribute it among multiple contracts and dealers. In a particular embodiment, predefined criteria are established for allocation of a contribution to multiple contracts. Upon receiving funds from a securities dealer 100, the SPE 110 applies the predefined criteria and distributes the contribution accordingly. Alternatively, distribution instructions can be given by the SPE 110 to the securities dealer 100 which can then provide direct contributions to the various contracts, such as shown in FIG. 1a. Such predefined criteria can be selected to allow the SPE 110 to manage its operations automatically in order to avoid additional costs associated with active fund management.

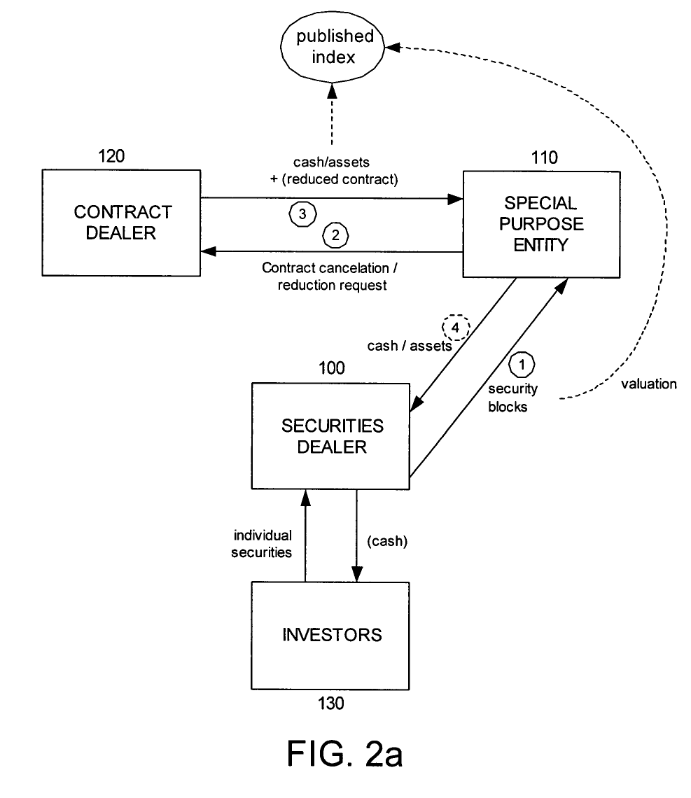

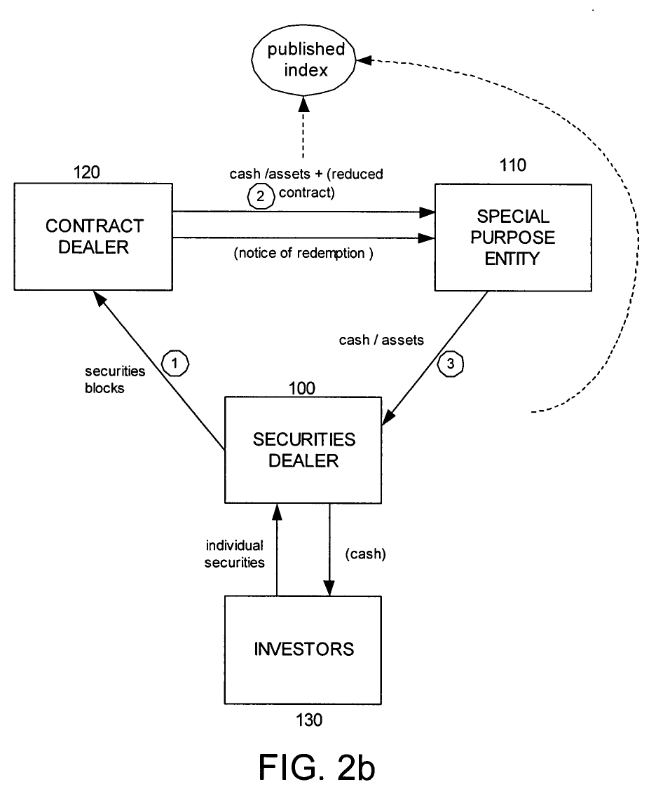

FIGS. 2a and 2b are simplified illustrations of a process flow for the redemption of securities by the security dealer 100. The securities dealer 100 accumulates blocks of individual securities to redeem, e.g., from individual investors 130 or in the form of shares created by the SPE and distributed to the securities dealer 100. With reference to FIG. 2a, the securities are then tendered to the SPE 110. The SPE 110, in response, issues a contract reduction (partial or total termination) request to the appropriate contract dealer(s) 120. Alternatively, as shown in FIG. 2b, if the contact dealer is suitably authorized, the securities can be tendered directly to the contract dealer(s) 120 by the securities dealer 100 on behalf of the SPE 110. Receipt of such a tender can be treated by the contract dealer 120 as a contract reduction request by the SPE 110 and suitable notice of the tender can be given to the SPE 110.

After the index value is published, such as at the end of a current trading session, the SPE 110, the contract dealer 120, or a suitable third party calculates the value which should be paid to the SPE 110 as a result of the reduction in the notional size of the contract(s). This amount is forwarded from the contract dealer(s) to the SPE 110 which then gives it to the securities dealer 100. If the securities dealer was redeeming shares on behalf of other investors 130, the funds received from the SPE 110 are distributed to these investors as appropriate.

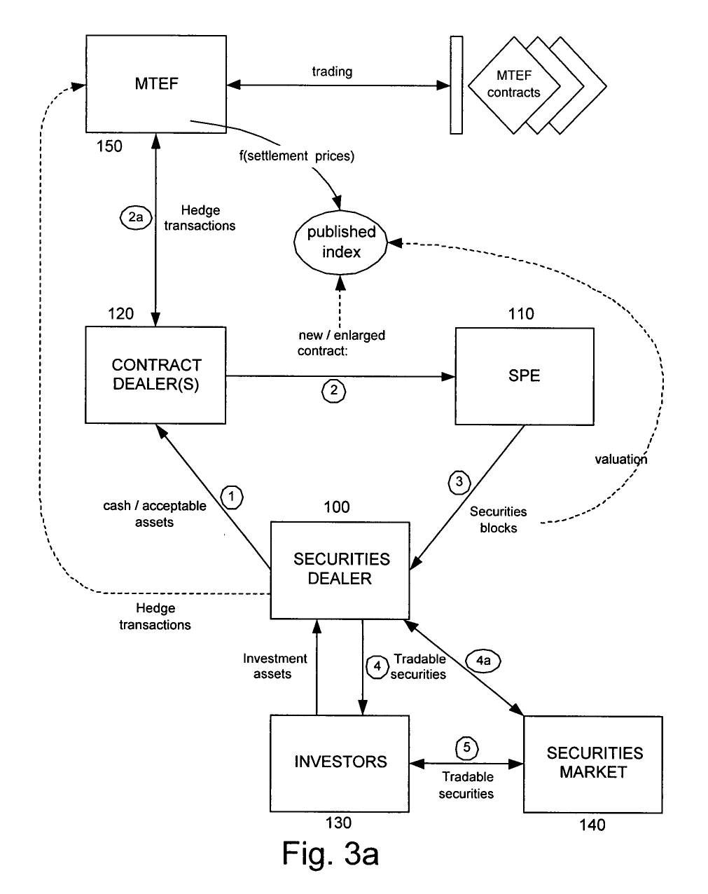

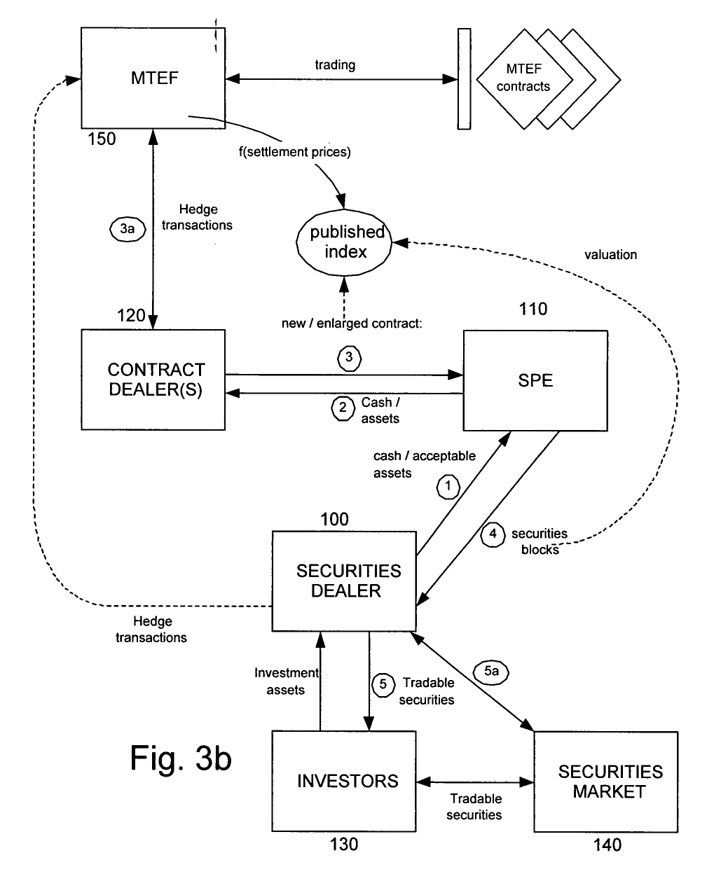

A more particular embodiment of the invention will now be discussed. Process flows for this embodiment are shown in FIGS. 3a and 3b, which generally correspond to the simplified flows shown in FIGS. 1a and 1b, discussed above.

The index referenced by the derivative contract(s) between the contract dealer 120 and the SPE 110 can be based on a variety of sources, such as the daily settlement value of contracts as listed on an MTEF 150. In a specific embodiment, the contracts relate to energy or metal futures as listed on the NYMEX. Various techniques are available for deriving an index value. In a particular implementation, the index value is a scaled weighting based on the daily settlement value of a designated set of futures contracts and reflects a rolling window of a predetermined time period, such as 4 months. The index is published by the MTEF 150 or an authorized third party on a periodic basis, such as on a daily basis after the close of trading. A value for the index can also be published during a trading period based upon the instantaneous settlement values. Such an estimated value can be useful, for example, in estimating the value of the derivative contract assets linked to the index and held by the SPE 110 to determine how closely an estimated value for the securities issued by the SPE 110 tracks the price at which those units are traded in a securities market.

The SPE 110 can have various forms. In one specific embodiment, the SPE 110 comprises a trust, such as a Delaware business trust or similar vehicle, that qualifies as a grantor trust (e.g., a special purpose passive investment vehicle) for tax purposes. The trust is established for a fixed, finite term, such as 25 years. The SPE's primary asset in this embodiment is a derivative contract, or several substantially identical derivative contracts, entered into with one or more contract dealers in commodity derivatives. A preferred set of terms for the derivative contract is described more fully below. The SPE 110 can also have cash or other assets pending distribution to shareholders. Such cash and assets can be held or invested in certain specified “permitted investments” pending distribution.

In general, the operating parameters for the trust, such as the type and manner in which it will hold assets and the manner and conditions under which it will issue securities, are specified in a trust agreement or other legal document, such as a declaration of trust or trust charter. The precise nature and title of the document is dependent on the manner and jurisdiction in which the trust is established. As used herein, any and all such documents will be generally referred to as a trust agreement.

The SPE 110 is authorized, by the terms of its trust agreement, for example, to issue and redeem shares, typically in large blocks or creation units. A market participant seeking to redeem or create shares can use futures or similar contracts traded on the MTEF 150 plus cash and/or other acceptable assets to induce a contract dealer 120 to deliver the appropriate derivative contracts to the SPE 110. This facilitates the liquidity of the tradable securities since a securities dealer 100 can acquire the MTEF contract and freely transfer this to the contract dealer 120 where it can be used to hedge the increased payment obligation of the contract dealer to the SPE associated with the increase in the notional value of the contract (which itself allows the creation of securities by the SPE 110 for delivery to the securities dealer). Thus, when the contract dealer 120 issues or increases the value of a contract with the SPE 110, the hedge received by the contract dealer 120 from the securities dealer 110 can be used to substantially offset the economic risk of the contract. This may advantageously facilitate liquidity in the securities by permitting various market participants to efficiently manage the risks associated with the redemption and creation of securities.

On a daily basis (or other periodic basis as determined in the SPE's trust agreement), the SPE 110 stands ready to offer to sell or redeem its shares at prices based on that day's closing net asset value for the SPE's held assets. Sales and redemptions are made in creation units or other designated block sizes and, preferably, only authorized securities dealers, such as designated specialists and market makers, and perhaps other arbitrageurs, will be authorized to purchase securities directly from the SPE 110 and redeem the same.

In a particular embodiment, only one class of securities is issued by the SPE 110. These securities represent ownership of a specific corresponding stated amount of one or more of the derivative contracts held by the SPE 110 as well as a corresponding proportionate amount of any cash or other assets held by the SPE 110. Each security has a price determined by the index as of the time of issuance, and preferably all securities issued at the same time have the same initial issue price, such as $100 stated amount per Unit. When the SPE is a trust that qualifies as a grantor trust, the security holders can be considered grantors of the trust under sections 671-677 of the Internal Revenue Code of 1986, as amended.

Transactions with the SPE 110 are preferably settled in cash. However, particularly when the securities dealers 100 make transfers directly to a contract dealer 120, the settlement can also include other acceptable assets. Because contract dealers 120 are expected to hedge the derivative contracts with contracts that are traded on the MTEF 150, an MTEF traded contract is a very suitable form of such other acceptable assets.

In particular, securities dealers 100 can acquire units in one of two ways: (i) for cash alone, or (ii) for cash and other property (a “partial exchange transaction”). The other property is preferably a derivative contract, such as a futures contract. Thus, the party effecting the exchange will transfer either an amount of cash or cash as well as certain contracts traded on the MTEF 150 to the contract dealer 120, either directly (FIG. 3a) or indirectly via the SPE 110 (FIG. 3b). In the case of a partial exchange transaction, the contracts transferred would be those that have a value the changes to which is well correlated with the commodities reflected in the index. The contract dealer 120 will, substantially simultaneously with such contribution, issue notice of the receipt and increase the stated amount of the derivative contract with the SPE 110. Upon receipt of such notification, the SPE 110 will issue the appropriate number of securities to the security dealer 100.

After receiving the securities, the securities dealers 100 are free to unbundle the creation units and transfer the securities to its investor customers and/or trade individual securities through an approved securities market 140, such as the PHLX, at prices set by current bids and offers. No security holders will be required to pay in excess of the security's initial purchase price.

Similarly, securities can be redeemed by a securities dealer 100 at any time, in which event a cash and/or other asset termination payment will be made by the contract dealer 120 as provided by the terms of the derivative contract. The notional amount of the derivative contract will be reduced accordingly and such cash and/or assets will be distributed to the securities dealer. In some circumstances, it may be suitable for the termination payment to include non-cash items, such as commodity futures. To simplify the transaction when the payment includes such a non-cash component, the payment can be made directly to the party redeeming the units.

In a particular implementation, both individual securities and creation units are held solely in “street name” through the Depository Trust Company in book-entry form and the SPE 110 will not issue individual certificates or know the identity of its individual investor(s). The SPE 110 can also seek an exemption from any otherwise applicable requirement that its prospectus be delivered in connection with the secondary market trading in its securities. This will result in lower costs and otherwise facilitate secondary market trading.

In conjunction with the daily offer to sell and redeem securities, the SPE 110 can make Fund/NAV related information available. This information permits specialists, market makers and other arbitrageurs to perform their own calculations as to the appropriate value of the securities traded on the securities market. Market forces will ensure that the price of the units on the securities market will generally not materially lag behind changes in the NAV.

Various forms of the derivative contract between the SPE 110 and a designated contract dealer 120 can be used. In a particular embodiment, the derivative contract provides for a stated amount which corresponds to the amount contributed in exchange for securities (either in cash or in a “partial exchange transaction”), and has a term that corresponds to the term of the SPE 110. The derivative contract preferably specifies that it is the intention of all parties that the contract be classified as a “forward contract” for US federal income tax purposes.

The derivative contract can also require, upon its initiation, that an up-front payment be made by the SPE 110 (or by a securities dealer 100 on behalf of the SPE 110) either in cash, in the form of commodities contracts transferred to the contract dealer 120, or both, and which corresponds to the amount contributed by the securities dealer 100 in exchange for securities. This amount constitutes the initial stated amount of the derivative contract.

Upon receipt of notification from the SPE 110 that securities have been redeemed (which may occur at any time), the contract dealer 120 will be obligated by the contract with the SPE to make a payment in termination of the portion of the derivative contract corresponding to the redeemed securities. The amount of this termination payment is determined with reference to the performance of the index during contract period. In an example scenario, the index is at 100 when the contract is initiated and the initial stated amount (the notional size) of the contract is 100. If, when a full redemption occurs, the index is at 125, the required termination payment would be 125. As partial termination/redemptions are made, the stated amount of the derivative contract is reduced accordingly.

As noted above, the derivative contract will provide that its stated amount can be increased at any time by providing a further contribution (either in cash or pursuant to an exchange transaction). In practice, increases and terminations are typically netted and the derivative contract re-sized on a periodic basis, such as daily.

Because the contract dealer 120 will be obligated to make termination payments that are calculated by reference to the performance of the index, the contract dealer 120 may find it advantageous to hedge its exposure to the index by entering into commodities futures contracts on the MTEF 150. As is known to those of skill in the art, when a party enters into such a hedge contract, the party is not required to make an full up-front payment. Instead, a certain amount of cash must be reserved in a margin account to secure the party's future obligations under the futures contract. This amount is typically a small fraction of the amount that may ultimately be owed under the contract.

According to one aspect of the invention, the contribution made to the contract dealer 120 can have various compositions. For example, the contract dealer 120 can receive cash equal to the value of the shares to be issued by the SPE 110 and one or more futures contracts which can be used to hedge its contract with the SPE 110. A portion of the up-front payment received by the contract dealer 120 (from the SPE 110 or securities dealer 100) can be used by the contract dealer 120 to make the margin payments associated with the received futures contract and the remainder of the up-front payment can be used for other purposes. Alternatively, the securities dealer can satisfy the margin payment and reduce the cash component of the contribution by an amount equal to the margin (and possibly associated transaction costs).

The contract with the SPE 100 can obligate the contract dealer 120 to, on a periodic basis (such as quarterly), to pay to the SPE 110 an amount of cash determined as a percentage of the initial stated amount. This percentage can fluctuate, e.g., in response to overnight interest rates. The periodic payments can be considered as compensation to securities holders for use of the up-front payment in excess of the amount actually (or expected to be) required by the contract dealer 120 to hedge its position. These periodic payments can be used by the SPE 110 to pay its expenses and any excess can be distributed to securities holders upon or shortly after receipt.

By way of a specific example, a securities dealer 100 buys $X worth of securities from the SPE 110 by providing the contract dealer 120 (directly or via the SPE 110) with a contribution having a total value of $X and including cash and a futures contract for a commodity (including the initial margin deposit associated with it), the value of which is reflected in the index on which the derivative contract at issue is based. The futures contract obligates the securities dealer 120 to pay $X at the end of the futures contract term. The particular attributes of the futures contract is dependant upon the commodity at issue and other factors and the futures contract will generally have attributes that are comparable to similar futures contracts trading on the MTEF 150. As is understood by those of skill in the art, beyond any initial margin deposit, the securities dealer incurs no immediate cost associated with this futures contract (except possibly for a minimal transaction cost) since the value of the futures contract accrues with changes in price of the underlying commodity and no changes have yet occurred.

The securities dealer 100 thus provides $X in cash and/or other property (directly or indirectly) to the contract dealer 120 as a prepayment of the security dealer's obligation under the futures contract. As a result, the securities dealer 100 has no further obligation with regard to the futures contract and has, in effect, paid $X for $X worth of the issued securities.

Since at the completion of the transaction, the obligations associated with the futures contract rest with the contract dealer 120, the identity of the party who provides the futures contract to the contact dealer 120 is of only secondary importance. Thus, while preferably, the futures contract is provided by the securities dealer 120, alternatively, the securities dealer 120 could provide cash to the SPE 110 and the SPE 110 would provide the contract dealer 120 with a futures contract and the cash pre-satisfy its obligations under the futures contract. Involvement by other parties is also possible.

As will be appreciated, the contract dealer 120 will have to make a margin deposit to support the futures contract. The margin is typically on the order of 5% of the $X base for the futures contract. Because the contract dealer 120 has received the entire payment due under the futures contract ($X) up front, it can use a portion of the received cash to make the required margin payment, leaving most of the received cash in reserve to satisfy future obligations that might arise with respect to the received asset. Alternatively, and as noted above, the securities dealer can make the margin payment itself before transferring the futures contract to the contract dealer and reduce the cash component of the transfer a corresponding amount.

Advantageously, this methodology allows the contract dealer 120 to issue (or increase the size of) the derivative contract with the SPE 110 with substantially no market risk based upon changes in the index. The received futures contract is linked to the index or a source for the index and acts as a hedge against the derivative contract with the SPE. The received cash from the securities dealer is adequate to meet the contract dealer's obligations to maintain the received asset and appreciation of the asset (or subsequent instruments obtained in exchange for the asset, e.g., as the result of rolls) and the residual cash (possibly along with the asset or a subsequent instrument) is generally sufficient to satisfy the termination payment to the SPE 110 provided by the derivative contract.

As will be appreciated, the present methodology provides a mechanism whereby exchange tradable securities are issued in a way that permits investors to participate in price changes that occur on a futures market without having to enter the future market itself. The issued securities also have various risk/reward attributes that generally move in conjunction with positions available in futures markets. More generally, the invention provides the ability to move trading from one market with an associated regulatory scheme to a different market with a different regulatory scheme.

Advantageously, the present fund, in its preferred embodiments, can be a simpler product than conventional ETFs from a regulatory viewpoint. The SPE 110, as a form of Delaware business trust, or similar vehicle that qualifies as a grantor trust, allows for pass through tax treatment that allows the SPE 110 itself to minimize taxation. By assuring that the SPE 110 holds as its principal asset derivative contracts (such as a forward contract or possibly swaps) on an index, rather than securities, it is not subject to regulation as a registered investment company under the Investment Company Act of 1940. As a result, there is no need to engage in the often lengthy and expensive process of obtaining an otherwise necessary exemptive order from the SEC.

The invention has been described above in terms of its preferred implementation and embodiments. However, various changes in the form and details can be made without departing from the spirit and scope of the invention. For example, while the invention has been discussed in terms of tradable securities, the disclosed methodology can also be applied to other types of tradable units.

The process flow diagrams in the figures include numbers that generally indicate the sequence of the process. However, these numbers are for references and various steps in the process may occur simultaneously or in a somewhat different order than depicted. In addition, various names may be given to parties who fulfill the roles of the parties as specified above. It is intended that the terminology used herein be given its broadest interpretation consistent with the disclosure so that, for example, a contract dealer is any party who enters into a contract with an SPE as discussed herein regardless of whether that party is actually referred to by a different name.

We claim:

1. A special purpose entity comprising:
a trust that qualifies as a grantor trust, having a trust agreement, and which is established for a predetermined term;
the trust having assets substantially comprising at least one derivative contract between the trust and at least one party, each respective contract having a notional value, being tied to an index related to items traded by a multilateral transactional execution facility, and being structured to permit the notional value to be increased on demand in exchange for a corresponding contribution to the respective party and decreased on demand in exchange for a corresponding termination payment from the respective party of an amount determined with reference to a current value of the index;
the trust agreement permitting the trust to issue exchange tradable securities on a periodic basis in response to a contribution made to at least one particular party that results in an increase in the notional value of at least one of the at least one derivative contract held as an asset;
the trust agreement permitting the trust to redeem exchange tradable securities on the periodic basic, the redemption being associated with a reduction in the notional value of at least one of the one at least one derivative contract held as an asset and a termination payment from the respective at least one party of an amount determined with reference to a current value of the index and the respective amount of the notional value reduction.

2. The special purpose entity of claim 1, wherein the trust agreement permits the issuance and redemption of securities in creation units.

3. The special purpose entity of claim 1, wherein the periodic basis is daily.

4. The special purpose entity of claim 1, wherein the multilateral transaction execution facility is a futures exchange and the index is based on prices of items traded on the futures exchange, and each of the at least one derivative contract is a forward contract.

5. The special purpose entity of claim 1, wherein other than the respective party and the respective notional value, each of the at least one derivative contract is substantially identical.

6. An exchange tradable security issued by a special purpose entity having assets substantially comprising at least one derivative contract between the special purpose entity and a corresponding party, each respective contract having a notional value, being tied to an index related to items traded by a multilateral transactional execution facility, and being structured to permit the notional value to be increased on demand in exchange for a corresponding contribution to the respective party and decreased on demand in exchange for a corresponding termination payment from the respective party of an amount determined with reference to a current value of the index.

7. The exchange tradable security of claim 6, wherein the special purpose entity is a trust that qualifies as a grantor trust and which is established for a predetermined term.

8. The exchange tradable security of claim 6, wherein the multilateral transaction execution facility is a futures exchange, the index is based on settlement values of items traded on the futures exchange, and the derivative contract is a forward contract based on the index.
